(19) United States
(12) Patent Application Publication
(10) Pub. No.: US 2026/0189147 A1
(43) Pub. Date: Jul. 2, 2026

(54) MULTI-PHASE POWER CONVERTER AND CONTROL METHOD THEREOF

(71) Applicant: Richtek Technology Corporation, Hsinchu (TW)

(72) Inventors: Fu-Shiang LAI, Hsinchu (TW); Wei-Chuan WU, Hsinchu (TW); Ting-Jung TAI, Hsinchu (TW)

(21) Appl. No.: 19/308,309

(22) Filed: Aug. 24, 2025

Related U.S. Application Data
(60) Provisional application No. 63/738,838, filed on Dec. 26, 2024.

(30) Foreign Application Priority Data
Jun. 23, 2025 (TW) 114123523

(51) Int. Cl. H02M 3/158

(52) U.S. Cl. CPC H02M 3/1586

(57) ABSTRACT

A multi-phase power converter includes: a plurality of power stage circuits, configured to convert an input voltage to an output voltage, wherein the plurality of power stage circuits are coupled to the input voltage, each power stage circuit including at least one switch controlling a corresponding inductor, wherein the inductor deliver energy to the output voltage; a current sensing circuit coupled to the plurality of power stage circuits and configured to sense an inductor current flowing through each inductor of the corresponding power stage circuit; and a control circuit comprising an instantaneous current response module configured to trigger an instantaneous current response to increase or decrease a number of operating phases of the plurality of power stage circuits when at least one of the inductor currents exceeds an instantaneous current threshold, thereby suppressing an overshoot or an undershoot of the output voltage.

### CROSS REFERENCE

The present invention claims priority to provisional application 63/738,838 filed on Dec. 26, 2024, and TW 114123523 filed on Jun. 23, 2025.

### BACKGROUND OF THE INVENTION

### Field of Invention

The present invention relates to a switching power converter and a control method thereof, and more particularly to a multi-phase power converter and control method for adaptively adding and shedding operating phases according to an inductor current.

### Description of Related Art

With the increasing functional diversity and ever-improving processing capability of electronic products, the demand for stable and high-efficiency power supply has also been rising. Multi-phase power converters are widely used in high performance, high current applications to improve power delivery efficiency and reduce output voltage ripple. FIG. 1A illustrates a typical prior art multi-phase power converter in a four-phase buck architecture with parallel power stage circuits. The converter includes four power stage circuits (PS1 to PS4). The first phase power stage PS1 includes an upper bridge switch Q1H, a lower bridge switch Q1L, and an inductor L1. The second phase power stage PS2 includes an upper bridge switch Q2H, a lower bridge switch Q2L, and an inductor L2. The third phase power stage PS3 includes an upper bridge switch Q3H, a lower bridge switch Q3L, and an inductor L3. The fourth phase power stage PS4 includes an upper bridge switch Q4H, a lower bridge switch Q4L, and an inductor L4. The inputs of the four power stage circuits are coupled to the input voltage VIN, and, through the respective inductors, transfer energy to the output node VO, thereby forming a multi-phase buck configuration that jointly provides a regulated output voltage VO to achieve load current sharing and improved overall efficiency.

FIG. 1B illustrates a schematic relationship between a load current ILOAD and a power conversion efficiency EFF for the prior art. As shown, in order to improve efficiency, the prior art automatically performs phase adding and phase shedding according to a magnitude of the ILOAD. From left to right, the curves represent: a single operating phase in discontinuous conduction mode (DCM); a single operating phase in continuous conduction mode (CCM); two operating phases; and three operating phases. As the ILOAD decreases, the number of operating phases is gradually reduced; as the ILOAD increases, the number is gradually increased. Traditional schemes mainly determine phase adding/shedding based on an averaged inductor current of the operating phases. Although such average current monitoring can filter ripple and avoid frequent toggling (e.g., chatter around a boundary), the average current monitoring entails response latency: when the ILOAD increases or decreases abruptly, the phase count is not switched immediately. As a result, the output voltage often exhibits undershoot/overshoot and subsequent ringing. In particular, under fast load transients, compensation of the current loop and the voltage loop may excite output voltage ringing and further impair system stability.

FIG. 1C shows related signal waveforms of a prior art multi-phase power converter. From top to bottom, the three signal waveforms are the load current ILOAD, instantaneous inductor currents IL (including a first phase inductor current IL1 and a second phase inductor current IL2), and the output voltage VO. At time t1, ILOAD increases abruptly, and IL1 rises accordingly under closed loop control. At time t2, because an average inductor current of all phases (and likewise the first phase average) exceeds a predetermined averaged current threshold (not shown), the second phase is enabled and the IL2 begins to rise. Between t1 and t2, VO exhibits a pronounced undershoot (US) and subsequent oscillation. Later, at time t3, ILOAD drops abruptly. A feedback loop causes IL1 and IL2 to start decreasing, yet the second phase power stage does not turn OFF until time t4. During this interval, VO exhibits an overshoot (OS) followed by voltage ringing, which degrades output stability.

Please also refer to FIG. 1D, which shows another related signal waveforms of the prior art multi-phase power converter to further explain an additional drawback. An upper signal waveform represents VO, and lower two signal waveforms respectively show the first phase inductor current IL1 and the second phase inductor current IL2. In certain transient conditions, when the load current increases at time t5, IL1 rises. Once the first phase's average inductor current exceeds a predetermined averaged current threshold (not shown), the first phase's instantaneous inductor current IL1 simultaneously triggers over current protection, such that IL1 is limited at a current limit level CL. Due to delayed response in the prior art, the second power stage does not start operation until time t6, which increases the magnitude of an undershoot US′ of VO and further degrades output voltage stability.

### SUMMARY OF THE INVENTION

From one perspective, the present invention provides a multi-phase power converter, comprising: a plurality of power stage circuits, configured to convert an input voltage to an output voltage, wherein the plurality of power stage circuits are coupled to the input voltage, each of the power stage circuits including at least one switch controlling a corresponding inductor, the inductor delivering energy to the output voltage; a current sensing circuit coupled to the plurality of power stage circuits and configured to sense an inductor current flowing through the inductor of the each power stage circuit; and a control circuit comprising an instantaneous current response module configured to trigger an instantaneous current response to increase or decrease a number of operating phases of the plurality of power stage circuits when at least one of the inductor currents exceeds an instantaneous current threshold, thereby suppressing an overshoot or an undershoot of the output voltage.

In one embodiment, the multi-phase power converter further comprises an average current circuit coupled to the plurality of power stage circuits and configured to average a plurality of inductor currents of the plurality of power stage circuits to generate an average current; wherein the control circuit further includes an average current response module configured to determine the number of operating phases according to the average current and at least one average current threshold, thereby improving a conversion efficiency.

In one embodiment, the multi-phase power converter further comprises an output voltage sensing circuit coupled to the plurality of power stage circuits and configured to sense the output voltage; wherein the control circuit further comprises an instantaneous voltage response module configured to trigger an instantaneous voltage response to increase or decrease the number of operating phases when a variation of the output voltage exceeds an instantaneous voltage difference threshold, thereby suppressing an overshoot or an undershoot of the output voltage.

In one embodiment, in the instantaneous voltage response, the instantaneous voltage response module drives all of the plurality of power stage circuits to operate or disables all of the plurality of power stage circuits for a predetermined period.

In one embodiment, the average current circuit comprises a plurality of low-pass filters respectively corresponding to the plurality of power stage circuits and configured to low-pass filter the plurality of inductor currents to obtain the average current.

In one embodiment, the current sensing circuit comprises: a forward inductor current sensing circuit configured to sense a forward inductor current of the inductor current in each of the power stage circuits; or a reverse inductor current sensing circuit configured to sense a reverse inductor current of the inductor current in each of the power stage circuits; wherein the instantaneous current response module is configured to trigger the instantaneous current response to increase or decrease the number of operating phases when at least one forward inductor current exceeds an instantaneous forward current threshold and/or at least one reverse inductor current exceeds an instantaneous reverse current threshold.

In one embodiment, in the instantaneous current response, the instantaneous current response module drives all of the plurality of power stage circuits to operate, or disables other power stage circuits except one phase, such that only one phase power stage circuit remains operating for a predetermined period, thereby suppressing an overshoot or an undershoot of the output voltage.

In one embodiment, the instantaneous current threshold is greater than the at least one average current threshold.

In one embodiment, when the control circuit decreases the number of operating phases, during a transient period, one of an upper bridge switch and a lower bridge switch of the at least one switch of the power stage circuit being turned OFF is kept in an OFF state, such that an inductor current flows through a body diode of the upper bridge switch or the lower bridge switch that is turned OFF, to increase an absolute value of a voltage across the inductor, thereby shortening the transient period.

From another perspective, the present invention provides a control method for controlling a multi-phase power converter, wherein the multi-phase power converter comprises a plurality of power stage circuits configured to convert an input voltage to an output voltage, the plurality of power stage circuits being coupled to the input voltage and each of the plurality of power stage circuits controlling a corresponding inductor through at least one switch, the inductor delivering energy to the output voltage, the control method comprising: sensing an inductor current flowing through the inductor of each power stage circuit; and triggering an instantaneous current response to increase or decrease a number of operating phases of the plurality of power stage circuits when at least one of the inductor currents exceeds an instantaneous current threshold, thereby suppressing an overshoot or an undershoot of the output voltage.

From another perspective, the present invention provides a control method for controlling a multi-phase power converter, wherein the multi-phase power converter comprises a plurality of power stage circuits configured to convert an input voltage to an output voltage, the plurality of power stage circuits being respectively coupled to the input voltage and each controlling a corresponding inductor through at least one switch, the inductor delivering energy to the output voltage, the control method comprising: sensing an inductor current flowing through the inductor of each power stage circuit; averaging a plurality of inductor currents of the plurality of power stage circuits to generate an average current; sensing the output voltage; determining a number of operating phases according to the average current and at least one average current threshold, thereby improving a conversion efficiency; triggering an instantaneous voltage response to increase or decrease the number of operating phases of the plurality of power stage circuits when a variation of the output voltage exceeds an instantaneous voltage difference threshold, thereby suppressing an overshoot or an undershoot of the output voltage; and when the variation of the output voltage does not exceed the instantaneous voltage difference threshold and at least one of the inductor currents exceeds an instantaneous current threshold, triggering an instantaneous current response to increase or decrease the number of operating phases, thereby suppressing an overshoot or an undershoot of the output voltage.

In one embodiment, the control method further comprises in the instantaneous voltage response, driving all of the plurality of power stage circuits to operate or disabling all of the plurality of power stage circuits for a predetermined period.

In one embodiment, the control method further comprises in the instantaneous current response, driving all of the plurality of power stage circuits to operate, or disabling other power stage circuits except one phase, such that only one phase power stage circuit remains operating for a predetermined period, thereby suppressing an overshoot or an undershoot of the output voltage.

In one embodiment, when a first number of operating phases determined according to at least one of the inductor currents exceeding the instantaneous current threshold is inconsistent with a second number of operating phases determined according to the average current and the average current threshold, the first number of operating phases is executed with priority as the number of operating phases.

In the previous embodiment, when the second number of operating phases is less than a first predetermined number, the inductor current is a forward inductor current, the first number of operating phases is greater than a second predetermined number, and the second predetermined number is greater than the first predetermined number; or when the second number of operating phases is greater than a third predetermined number, the inductor current is a reverse inductor current, the first number of operating phases is less than a fourth predetermined number, and the fourth predetermined number is less than the third predetermined number.

In one embodiment, the step of averaging the plurality of inductor currents of the plurality of power stage circuits to generate the average current comprises: low-pass filtering the plurality of inductor currents to obtain the average current.

The objectives, technical details, features, and effects of the present invention will be better understood with regard to the detailed description of the embodiments below, with reference to the attached drawings.

### BRIEF DESCRIPTION OF THE DRAWINGS

FIG. 1A illustrates a typical prior art multi-phase power converter.

FIG. 1B illustrates a schematic diagram showing a relationship between a load current (ILOAD) and a power conversion efficiency (EFF) of the prior art multi-phase power converter.

FIG. 1C illustrates a schematic diagram of related signal waveforms of the prior art multi-phase power converter.

FIG. 1D illustrates another schematic diagram of related signal waveforms of the prior art multi-phase power converter.

FIG. 2 illustrates a schematic diagram of a circuit of the multi-phase power converter according to one embodiment of the present invention.

FIG. 3 illustrates a schematic diagram of a circuit of the multi-phase power converter according to another embodiment of the present invention.

FIG. 4 illustrates a schematic diagram of a circuit of the multi-phase power converter according to one specific embodiment of the present invention.

FIG. 5 illustrates a schematic diagram of an average current circuit in the multi-phase power converter according to one embodiment of the present invention.

FIG. 6 illustrates a schematic diagram of one hysteresis comparator of an average current response module of the multi-phase power converter according to the present invention.

FIG. 7 illustrates a schematic diagram of an embodiment in which a lower bridge switch of a power stage circuit of the present invention is kept OFF during a transient period so that a corresponding inductor current flows through a body diode of the lower bridge switch.

FIG. 8 illustrates a diagram of related signal waveforms of one embodiment of the multi-phase power converter according to the present invention.

FIGS. 9A and 9B respectively illustrate diagrams of related signal waveforms of the prior art and one embodiment of the multi-phase power converter according to the present invention.

FIG. 10 illustrates a flowchart of operations of a control method according to one embodiment of the present invention.

FIG. 11 illustrates a flowchart of operations of an instantaneous voltage response of a control method according to one embodiment of the present invention.

FIG. 12 illustrates a flowchart of operations of an instantaneous current response of a control method according to one embodiment of the present invention.

FIG. 13 illustrates a flowchart of operations of triggering an instantaneous current response of a control method according to one embodiment of the present invention.

FIG. 14 illustrates a flowchart of operations of triggering an instantaneous current response of a control method according to one embodiment of the present invention.

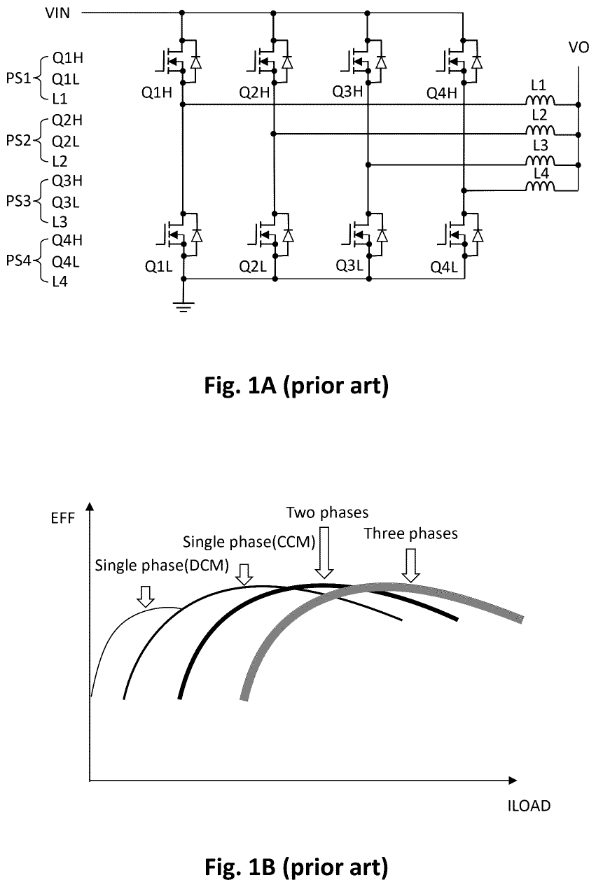

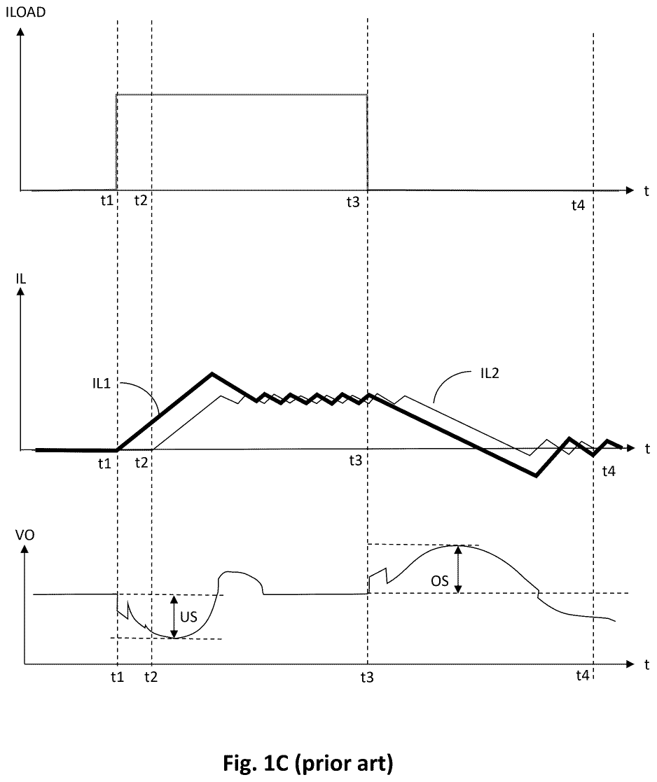

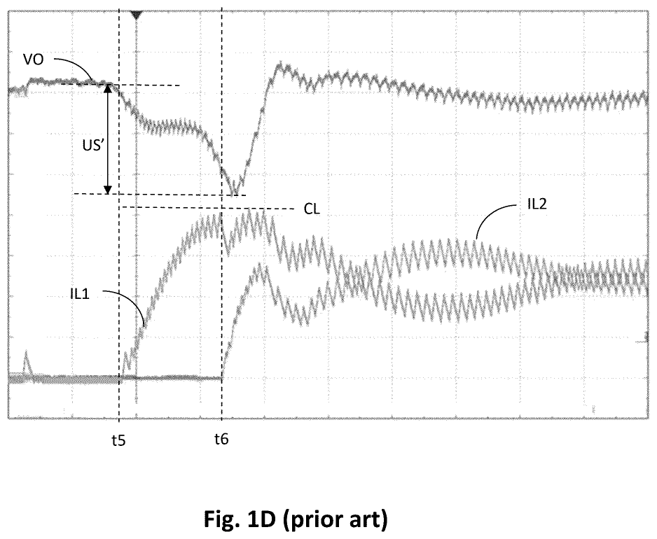

### DESCRIPTION OF THE PREFERRED EMBODIMENTS

The drawings as referred to throughout the description of the present invention are for illustration only, to show the interrelations between the circuits and the signal waveforms, but not drawn according to actual scale of circuit sizes and signal amplitudes and frequencies.

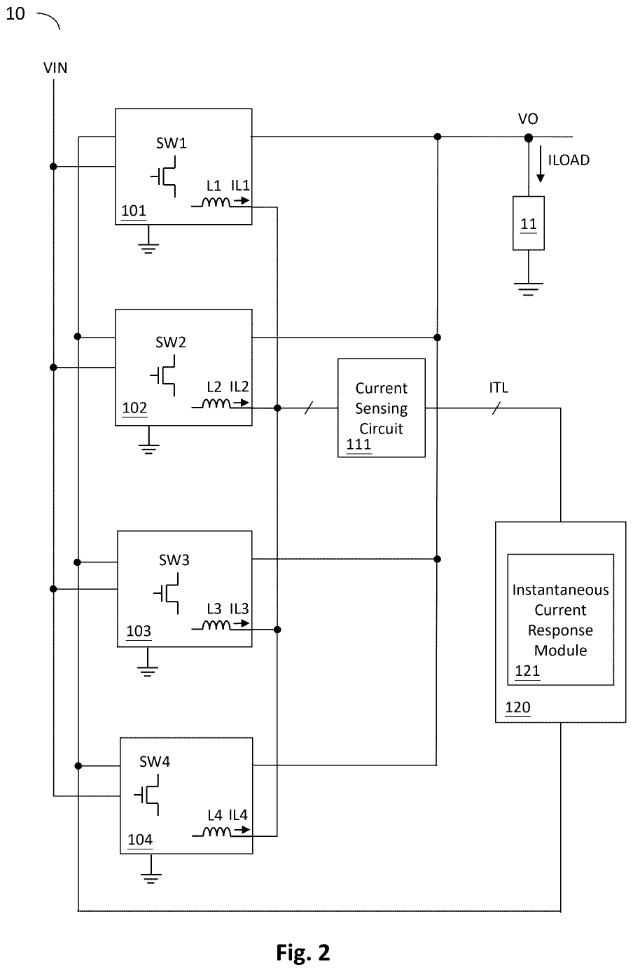

FIG. 2 illustrates a schematic diagram of a circuit of the multi-phase power converter according to one embodiment of the present invention. As shown in FIG. 2, a multi-phase power converter 10 comprises: a plurality of power stage circuits 101, 102, 103, and 104 configured to convert an input voltage VIN to an output voltage VO, wherein the plurality of power stage circuits 101, 102, 103, and 104 are respectively coupled to the input voltage VIN, and each of the power stage circuits including at least one switch SW1, SW2, SW3, and SW4 therein controls a corresponding inductor L1, L2, L3, and L4, the inductors L1, L2, L3, and L4 being configured to deliver energy to the output voltage VO; a current sensing circuit 111 coupled to the plurality of power stage circuits 101, 102, 103, and 104, configured to sense inductor currents IL1, IL2, IL3, and IL4 flowing through the corresponding inductors L1, L2, L3, and L4 of each power stage circuit 101, 102, 103, and 104; and a control circuit 120 comprising an instantaneous current response module 121 configured to trigger an instantaneous current response when at least one of the inductor currents IL1, IL2, IL3, or IL4 exceeds an instantaneous current threshold, so as to increase or decrease the number of operating phases of the plurality of power stage circuits 101, 102, 103, and 104, thereby suppressing an overshoot or undershoot of the output voltage VO. The multi-phase power converter 10 may rapidly adjust the number of operating power stages via the instantaneous current response module 121 according to the variation of a load current ILOAD, so as to ensure stability of the output voltage VO and further enhance conversion efficiency and power supply stability.

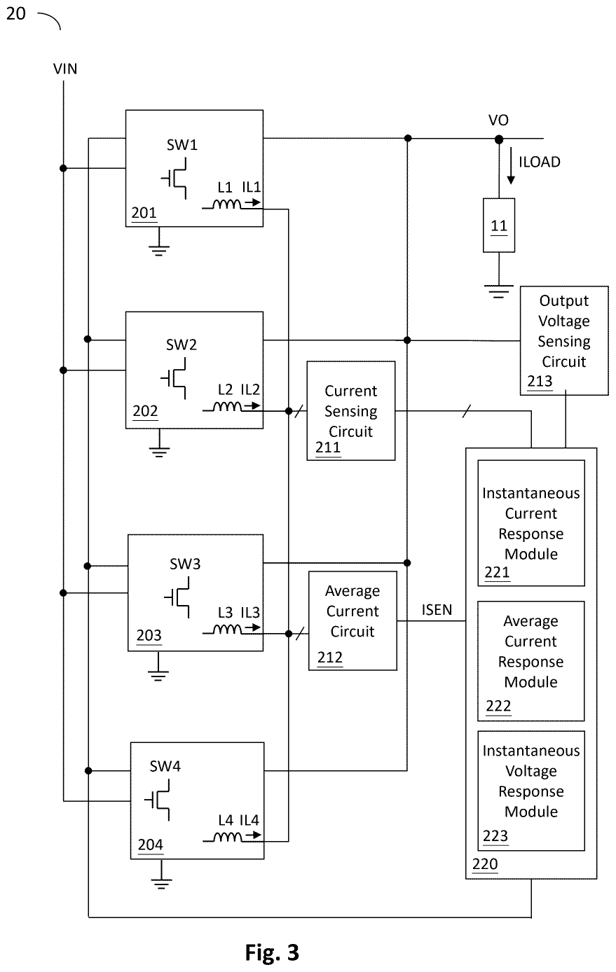

FIG. 3 illustrates a schematic diagram of a circuit of the multi-phase power converter according to another embodiment of the present invention. As shown in FIG. 3, a multi-phase power converter 20 comprises a plurality of power stage circuits 201, 202, 203, and 204 configured to convert an input voltage VIN to an output voltage VO, wherein the plurality of power stage circuits 201, 202, 203, and 204 are respectively coupled to the input voltage VIN, and each of the power stage circuits controls a corresponding inductor L1, L2, L3, and L4 via at least one corresponding switch SW1, SW2, SW3, and SW4, the inductors L1, L2, L3, and L4 being configured to transfer energy to the output voltage VO. The multi-phase power converter 20 further comprises a current sensing circuit 211, an average current circuit 212, and an output voltage sensing circuit 213. The current sensing circuit 211 is coupled to the plurality of power stage circuits 201, 202, 203, and 204, and configured to sense inductor currents IL1, IL2, IL3, and IL4 flowing through the corresponding inductors of each power stage circuit. The average current circuit 212 is also coupled to the plurality of power stage circuits 201, 202, 203, and 204, and configured to average the plurality of inductor currents to generate an average current ISEN. In addition, the output voltage sensing circuit 213 is coupled to the output voltage VO and configured to sense a variation of the output voltage VO.

In this embodiment, a control circuit 220 comprises an instantaneous current response module 221, an average current response module 222, and an instantaneous voltage response module 223. When the instantaneous current response module 221 detects that at least one of the inductor currents IL1, IL2, IL3, or IL4 exceeds an instantaneous current threshold, the instantaneous current response is triggered to increase or decrease the number of operating power stage circuits, thereby suppressing an overshoot or undershoot of the output voltage VO. The average current response module 222 is configured to determine the number of operating phases according to the average current ISEN and at least one average current threshold, so as to improve conversion efficiency. Furthermore, the instantaneous voltage response module 223 is configured to trigger an instantaneous voltage response when a variation of the output voltage VO exceeds an instantaneous voltage difference threshold, which, from one perspective, indicates that a load has a high variation slope (absolute value), so as to increase or decrease the number of operating power stage circuits, thereby suppressing an overshoot or undershoot of the output voltage VO.

In one embodiment, the instantaneous voltage response module 223 is configured to trigger an instantaneous voltage response when a variation of the output voltage VO exceeds an instantaneous voltage difference threshold, and, when an increase in the number of operating power stage circuits is required, to immediately drive all power stage circuits to operate simultaneously for a predetermined period to rapidly increase a total output current; or, when a decrease in the number of operating power stage circuits is required, to disable all power stage circuits for a predetermined period to rapidly reduce the total output current; it should be noted that the term “disable” refers to turning OFF both an upper bridge switch and a lower bridge switch of the corresponding power stage circuit having all its switching devices, including the upper bridge switch and the lower bridge switch for example, thereby rapidly suppressing an overshoot or undershoot of the output voltage VO. It is noted that the predetermined periods for driving all of the power stage circuits to operate simultaneously and for disabling all of the power stage circuits may be the same or different.

In one embodiment, during the instantaneous current response, the instantaneous current response module 221 is configured, when an increase in the number of operating power stage circuits is required, to drive all power stage circuits to operate for a predetermined period; or, when a decrease in the number of operating power stage circuits is required, to disable all power stage circuits except one phase for a predetermined period, thereby effectively suppressing an overshoot or undershoot of the output voltage VO.

Through such a multi-level and differentiated control approach, the multi-phase power converter 10 can effectively handle different degrees of load variation, maintain high stability of the output voltage VO, and achieve high conversion efficiency of the system. For example, in the multi-phase power converter of the present invention, three corresponding response mechanisms are set according to different variation slopes of the load current ILOAD: average current response, instantaneous current response, and instantaneous voltage response. The average current response refers to the above-mentioned mechanism of determining the number of operating phases according to the average current ISEN and at least one average current threshold.

The average current response is applicable when the variation slope of the load current ILOAD falls within a first slope variation range. When the variation of the load current ILOAD is slow and stable, such as when the load of the multi-phase power converter gradually changes, the average current response adjusts the number of operating phases through sensing the average value of the inductor current, thereby effectively improving conversion efficiency.

The instantaneous current response is applicable when the variation slope of the load current ILOAD falls within a second slope variation range, the variation speed of the load current ILOAD in the second slope variation range being higher than that in the first slope variation range. At this time, because the variation of the load current ILOAD is relatively fast, the average current response may not be sufficient to handle it in time. Therefore, the instantaneous current response immediately adjusts the number of operating phases according to whether the instantaneously sensed inductor current exceeds a predetermined instantaneous current threshold, so as to quickly suppress a potential overshoot or undershoot of the output voltage.

The instantaneous voltage response is specifically applicable when the variation slope of the load current ILOAD falls within a third slope variation range, the variation speed of the load current ILOAD in the third slope variation range being the highest. Such load transients are very drastic, for example, when a CPU rapidly switches from a low-power state to a high-power state, causing the output voltage to instantaneously exhibit a large deviation. In this case, relying solely on the average current response or the instantaneous current response may not be sufficient to stabilize the output voltage in time. Therefore, the instantaneous voltage response directly senses the instantaneous variation of the output voltage and immediately drives all power stages or temporarily stops operation of all power stages, so as to extremely quickly suppress drastic variation of the output voltage.

Accordingly, the present invention sets three different response strategies according to the variation slope of the load current ILOAD, with the following clear slope order relationship: the variation slope of the load current ILOAD in the first slope variation range is lower than that in the second slope variation range, and the variation slope of the load current ILOAD in the second slope variation range is lower than that in the third slope variation range, so as to effectively and precisely handle various load transient situations.

FIG. 4 illustrates a schematic diagram of a specific embodiment of the circuit of the multi-phase power converter of the present invention. As shown in FIG. 4, a multi-phase power converter 30 comprises a plurality of power stage circuits 301, 302, 303, and 304 configured to convert an input voltage VIN to an output voltage VO, wherein each of the power stage circuits 301, 302, 303, and 304 includes at least one switch configured to control a corresponding inductor L1, L2, L3, and L4, each inductor being configured to deliver energy to the output voltage VO.

The multi-phase power converter 30 further comprises a current sensing circuit 311, an average current circuit 312, an output voltage sensing circuit 313, and a control circuit 320. The current sensing circuit 311 comprises a forward inductor current sensing circuit 3111 and a reverse inductor current sensing circuit 3112, configured to sense a forward inductor current and a reverse inductor current of each power stage circuit, respectively, and to transmit corresponding forward sensing signals POC1-POC4 and reverse sensing signals NOC1-NOC4, corresponding to the inductor currents IL1, IL2, IL3, and IL4, to an instantaneous current response module 321 of the control circuit 320. In this embodiment, the forward inductor current sensing circuit 3111 and the reverse inductor current sensing circuit 3112, for example, obtain forward sensing signals POC1-POC4 related to the forward inductor currents of each phase of the power stage circuits 301, 302, 303, and 304, and reverse sensing signals NOC1-NOC4 related to the reverse inductor currents of each phase of the power stage circuits 301, 302, 303, and 304, according to the phase node voltages LX1, LX2, LX3, and LX4 of the power stage circuits 301, 302, 303, and 304.

It should be noted that the term “forward inductor current” refers to an inductor current flowing from the phase node through the inductor toward the output voltage, whereas the term “reverse inductor current” refers to an inductor current flowing in the opposite direction, from the output voltage through the inductor toward the phase node. Specifically, when at least one forward inductor current exceeds an instantaneous current threshold (the instantaneous current threshold being a positive value), an instantaneous current response is triggered to increase the number of operating power stage circuits 101, 102, 103, and 104; and when at least one reverse inductor current exceeds an instantaneous current threshold (the instantaneous current threshold being a negative value), an instantaneous current response is triggered to decrease the number of operating power stage circuits 101, 102, 103, and 104.

The average current circuit 312 averages the inductor currents IL1, IL2, IL3, and IL4 output from the power stage circuits 301 to 304 to generate an average current ISEN. In one embodiment, the average current circuit 312, for example, generates a signal related to the average current ISEN (still denoted herein as ISEN) according to drain voltages of the power switches of the power stage circuits 301, 302, 303, and 304 and corresponding inductor current signals CS1, CS2, CS3, and CS4.

The control circuit 320 comprises the instantaneous current response module 321, an average current response module 322, an instantaneous voltage response module 323, a feedback and pulse width modulation (PWM) circuit 324, and a phase number control circuit 325. The instantaneous current response module 321 triggers an instantaneous current response when at least one inductor current exceeds the instantaneous current threshold, so as to increase or decrease the number of operating power stage circuits. In one embodiment, during the instantaneous current response, the instantaneous current response module 321 drives all power stage circuits to operate for a predetermined period, or disables all power stage circuits except one phase for a predetermined period, thereby effectively suppressing overshoot or undershoot of the output voltage VO.

The average current response module 322 determines an optimal number of operating phases according to the average current ISEN and one or more average current thresholds, so as to improve conversion efficiency, and may operate with hysteresis comparison to prevent phase number oscillation near the thresholds from causing output voltage oscillation. In one embodiment, when the average current ISEN is less than a first average current threshold Vth1, the number of operating phases is one; when the average current ISEN is between the first average current threshold Vth1 and a second average current threshold Vth2, the number of operating phases is two; when the average current ISEN is between the second average current threshold Vth2 and a third average current threshold Vth3, the number of operating phases is three; and when the average current ISEN is greater than the third average current threshold Vth3, the number of operating phases is four.

The instantaneous voltage response module 323 is configured to determine whether an instantaneous variation of the output voltage VO exceeds an instantaneous voltage difference threshold Vthqr. When this threshold is exceeded, the instantaneous voltage response is triggered. In one embodiment, the phase number control circuit 325 drives all power stage circuits to operate simultaneously for a predetermined period or disables all power stage circuits for a predetermined period, thereby immediately and effectively suppressing overshoot or undershoot of the output voltage VO.

Furthermore, the feedback and PWM circuit 324 is configured to generate a reference PWM signal PWM0 based on the input voltage VIN, the output voltage VO, and a ramp signal RAMP in a feedback and PWM manner, to be provided as a reference signal to each power stage circuit. The method of generating the reference PWM signal PWM0 by the feedback and PWM circuit 324 is well known to those skilled in the art, and will not be described in detail herein.

The phase number control circuit 325 determines the operating power stage circuits according to the reference PWM signal PWM0 and outputs from the instantaneous current response module 321, the average current response module 322, and the instantaneous voltage response module 323, and generates PWM signals SPW1, SPW2, SPW3, and SPW4 to be input to the power stage circuits 301, 302, 303, and 304, respectively. Furthermore, the power stage circuits 301, 302, 303, and 304 respectively comprise driver circuits 3011, 3021, 3031, and 3041, configured to drive corresponding power switches according to the PWM signals SPW1, SPW2, SPW3, and SPW4 to convert the input voltage VIN to the output voltage VO.

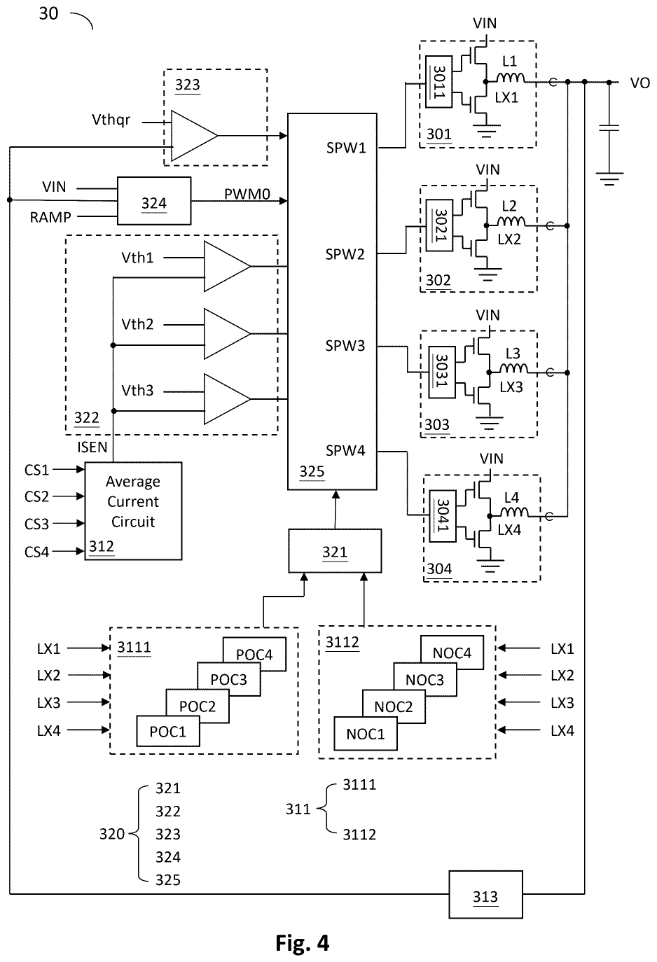

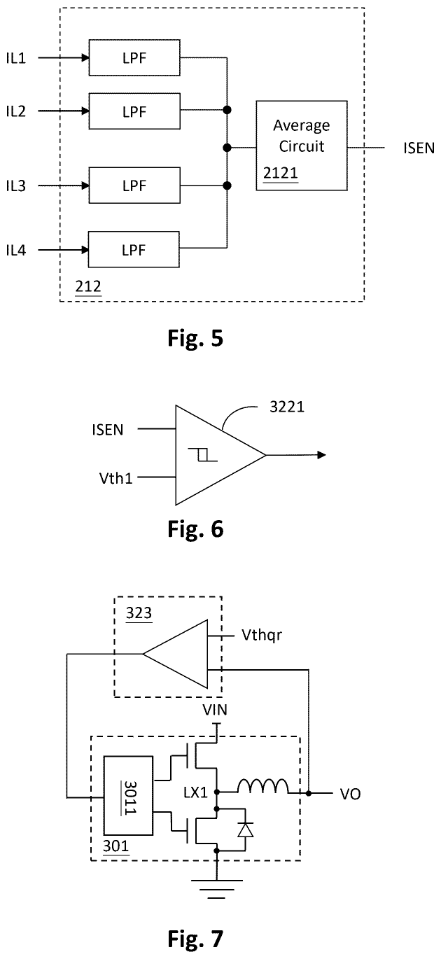

FIG. 5 illustrates a schematic diagram of one embodiment of the average current circuit in the multi-phase power converter of the present invention. As shown in FIG. 5, the average current circuit 212 comprises a plurality of low-pass filters (LPFs), each corresponding to an input of the inductor currents IL1, IL2, IL3, and IL4. Each LPF receives and low-pass filters the corresponding inductor current signal to filter out high-frequency noise and obtain a stable average or approximately average DC current signal. The output signals of the LPFs are then input to input terminals of an average circuit 2121. The average circuit 2121 may be any circuit suitable for performing signal averaging, including, but not limited to, a resistor network, an active averaging circuit formed of operational amplifiers, or other equivalent circuits. Through the average circuit 2121, a precise and effective mathematical average of the above multi-phase current signals can be calculated to form a stable and accurate average current ISEN, which is used by subsequent control circuits as a reference for phase number control, thereby improving power conversion efficiency and ensuring system stability.

FIG. 6 illustrates a schematic diagram of one embodiment of a hysteresis comparator 3221 of the average current response module 322 of the multi-phase power converter of the present invention. As shown in FIG. 6, the hysteresis comparator 3221 comprises two input terminals respectively receiving the average current ISEN and the first average current threshold Vth1. The hysteresis comparator 3221 has a built-in hysteresis characteristic such that, when the input average current ISEN exceeds an upper threshold (i.e., Vth1 plus the built-in hysteresis range), its output terminal generates a high-level signal to trigger the phase number control circuit 325 to increase the number of operating power stage circuits; conversely, when the average current ISEN drops below a lower threshold (i.e., Vth1 minus the built-in hysteresis range), its output terminal generates a low-level signal to trigger the control circuit to decrease the number of operating power stage circuits. Through this hysteresis characteristic, the average current response module 322 can avoid frequent switching near the first average current threshold Vth1, thereby effectively preventing oscillation of the output voltage VO and improving system stability and reliability.

FIG. 7 illustrates a schematic diagram of one embodiment of

the power stage circuit of the multi-phase power converter of the present invention, in which, when reducing the number of operating phases, a lower bridge switch is kept turned OFF during a transient period such that the inductor current flows through a body diode of the lower bridge switch, thereby shortening the transient response time. As shown in FIG. 7, the power stage circuit 301 comprises an upper bridge switch, a lower bridge switch, and a corresponding inductor. When the output voltage VO experiences an instantaneous variation exceeding a predetermined instantaneous voltage difference threshold Vthqr, the instantaneous voltage response module 323 triggers an instantaneous voltage response, thereby driving the power stage circuit 301 to perform a rapid adjustment of the number of operating phases.

In particular, when it is determined to reduce the number of operating phases of the power stage circuit 301, the instantaneous voltage response module 323 controls the lower bridge switch to remain in an OFF state, so that the inductor current originally flowing through the lower bridge switch instead flows through the body diode of the lower bridge switch. By this approach, a larger absolute value of the inductor voltage can be produced by the conduction of the body diode during the transient period, thereby rapidly reducing the inductor current and stabilizing the output voltage VO, effectively shortening the switching time of the transient response and improving the transient characteristics of the output voltage.

Furthermore, the control strategy of shortening the transient response time through conduction of the body diode can be applied not only in the above-described instantaneous voltage response mode, but also in cases where the instantaneous current response module and the average current response module determine to reduce the number of operating phases in the present invention, thereby further enhancing the overall dynamic response capability and stability of the system.

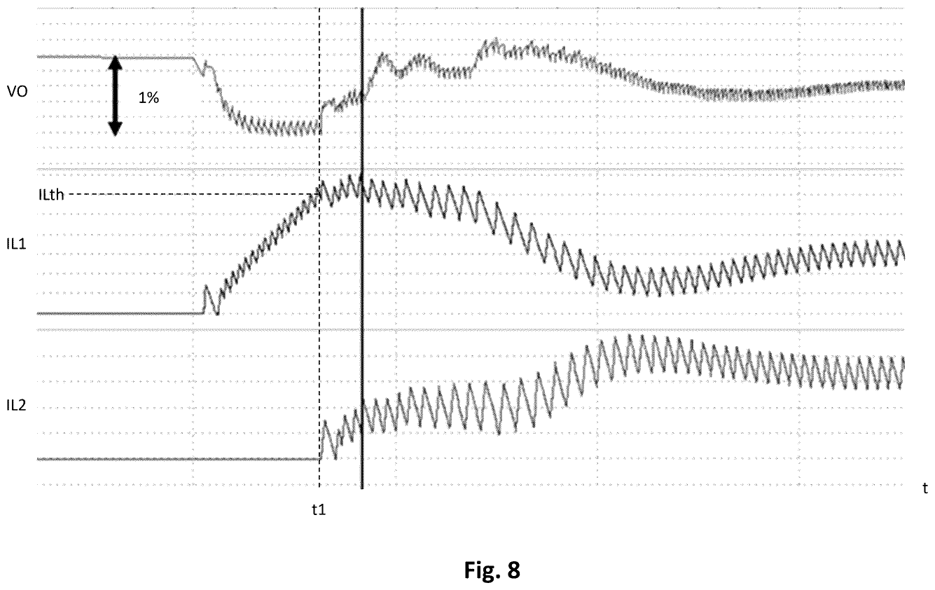

FIG. 8 illustrates a schematic diagram of related signal waveforms of one embodiment of the multi-phase power converter of the present invention. In this embodiment, from top to bottom, the variations of the output voltage VO and two-phase inductor currents IL1 and IL2 are sequentially shown, with the horizontal axis representing time t. As shown in FIG. 8, at time t1, the inductor current IL1 of the first phase reaches a set instantaneous current threshold ILth, at which time the instantaneous current response module immediately triggers an instantaneous current response, rapidly increasing the number of operating phases of the power stage circuits such that the inductor current IL2 of the second phase rapidly rises starting from time t1. Since, in this embodiment, another phase is added for operation before the inductor current IL1 of the first phase reaches a current limit, the current supply capability is effectively improved, and undershoot or overshoot of the output voltage VO is rapidly suppressed. In the prior art, when the instantaneous current response is triggered according to the embodiment of the present invention, the prior art average current monitoring mechanism has not yet triggered an increase/decrease of phases. That is, compared with the prior art, the present invention can suppress undershoot or overshoot of the output voltage VO more rapidly.

Therefore, the magnitude of undershoot of the output voltage VO can be significantly reduced. The undershoot magnitude of the output voltage shown in this embodiment can be reduced to only about 1% compared to the prior art, fully demonstrating that the instantaneous current response mechanism of the present invention can effectively improve the transient stability of the output voltage, and significantly enhance the system performance and reliability of the multi-phase power converter.

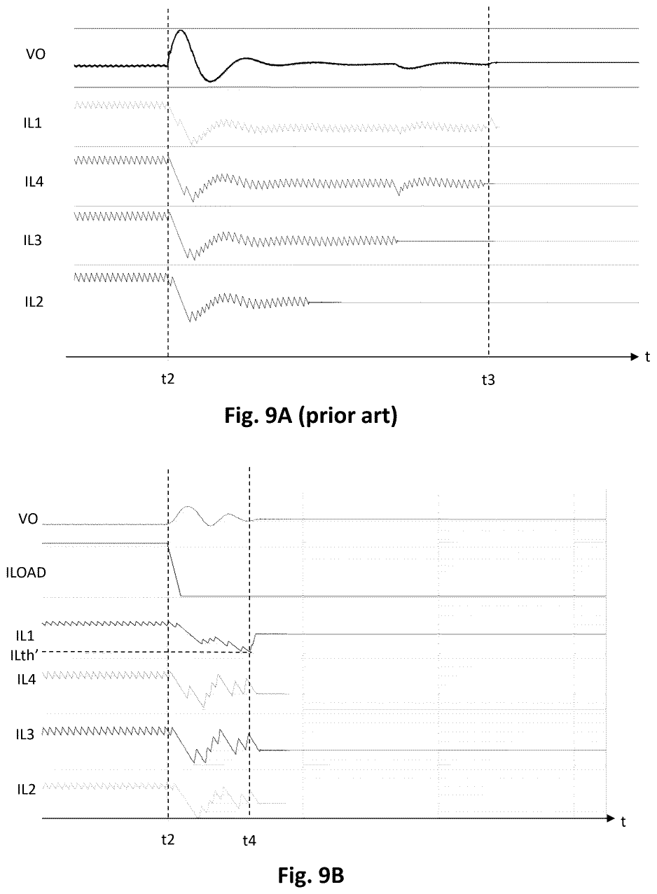

FIGS. 9a and 9b respectively illustrate comparison diagrams of related signal waveforms of a multi-phase power converter according to the prior art and an embodiment of the present invention. FIG. 9A sequentially shows, from top to bottom, the output voltage VO and inductor currents of each phase (such as the first-phase inductor current IL1, second-phase inductor current IL2, third-phase inductor current IL3, and fourth-phase inductor current IL4), with the horizontal axis representing time t. FIG. 9B sequentially shows, from top to bottom, the output voltage VO, the load current ILOAD, and inductor currents of each phase (such as the first-phase inductor current IL1, second-phase inductor current IL2, third-phase inductor current IL3, and fourth-phase inductor current IL4), with the horizontal axis representing time t.

As shown in FIG. 9A, in the related signal waveform diagram of the prior art multi-phase power converter, in a transient situation where the load current ILOAD suddenly drops at time t2, the control mechanism of the prior art determines the number of operating phases of the power stage circuits based on the average current. However, because the phase switching decision in the prior art is based on the measured value and determination of the average current and accompanied by an inherent delay time (such as between time t2 and t3), the actual timing for turning OFF redundant operating phases is significantly delayed, causing the output voltage VO to produce a larger overshoot and noticeable oscillation during the transient period, requiring a longer time to return to a stable state.

In contrast, as shown in FIG. 9B, in the related signal waveform diagram of the multi-phase power converter according to one embodiment of the present invention, after the load current ILOAD drops at time t2, when the first-phase inductor current IL1 rapidly drops below an instantaneous current threshold ILth′ at time t4, the instantaneous current response is immediately triggered to rapidly disable the other power stage circuits except the first-phase power stage circuit (i.e., disabling the second-phase power stage circuit, the third-phase power stage circuit, and the fourth-phase power stage circuit), retaining only a single phase (i.e., the first-phase power stage circuit) in operation. Due to this immediate phase adjustment, the output voltage VO can be rapidly stabilized in a shorter transient period, and the magnitude of overshoot and oscillation of the output voltage during the transient period can be greatly reduced.

In summary, compared to the prior art, the present invention, through the instantaneous current response module and the instantaneous current threshold determination mechanism, effectively shortens the phase adjustment time of the power stage circuits, significantly improves the transient response performance of the output voltage, suppresses oscillation and overshoot of the output voltage, and greatly enhances the stability and reliability of the multi-phase power converter.

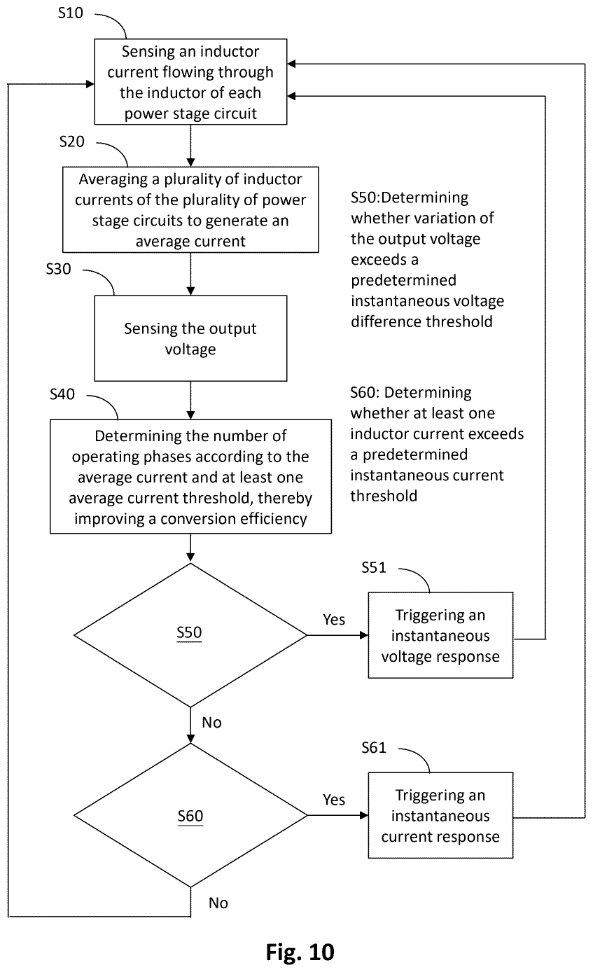

FIG. 10 illustrates a flowchart of a control method for the p multi-phase power converter according to one embodiment of the present invention. The control method is configured to control a multi-phase power converter comprising a plurality of power stage circuits, each coupled to an input voltage and each controlling a corresponding inductor via at least one switch, the inductor being configured to deliver energy to the output voltage.

In this embodiment, the process begins at step S10 is, sensing an inductor current flowing through the inductor of each power stage circuit.

Next, step S20 is, averaging a plurality of inductor currents of the plurality of power stage circuits to generate an average current, for example, by using multiple low-pass filters and an average circuit.

Next, step S30 is, sensing the output voltage to determine variation of the output voltage.

Next, step S40 is, determining the number of operating phases according to the average current and at least one average current threshold, thereby improving a conversion efficiency. For example, the generated average current is compared with at least one predetermined average current threshold to determine an appropriate number of operating phases, thereby improving overall conversion efficiency.

The process then proceeds to step S50, which is, determining whether variation of the output voltage exceeds a predetermined instantaneous voltage difference threshold. If so, the process proceeds to step S51, which is triggering an instantaneous voltage response to increase or decrease the number of operating phases, i.e., immediately to adjust the number of operating phases so as to rapidly suppress overshoot or undershoot of the output voltage, and, after completion of the instantaneous voltage response, returns to step S10 to continue the next control cycle.

If the determination in step S50 is negative, the process proceeds to step S60, which is further determining whether at least one inductor current exceeds a predetermined instantaneous current threshold. If so, the process proceeds to step S61, which is triggering an instantaneous current response to adjust the number of operating phases to maintain stability, and, after completion, returns to step S10. If the determination is negative, the process directly returns to step S10 to continue current and voltage monitoring and control, so that, when variation of the load current occurs, the control method can adaptively enter an instantaneous voltage response, an instantaneous current response, or determine the number of operating phases according to the average current.

Through the above cyclic control process, the present invention can perform instantaneous voltage response, instantaneous current response, and efficiency-oriented phase control according to multiple conditions of the output voltage, inductor current, and average current, thereby balancing conversion efficiency and output stability, and achieving the effects of dynamic load adaptation and precise adjustment.

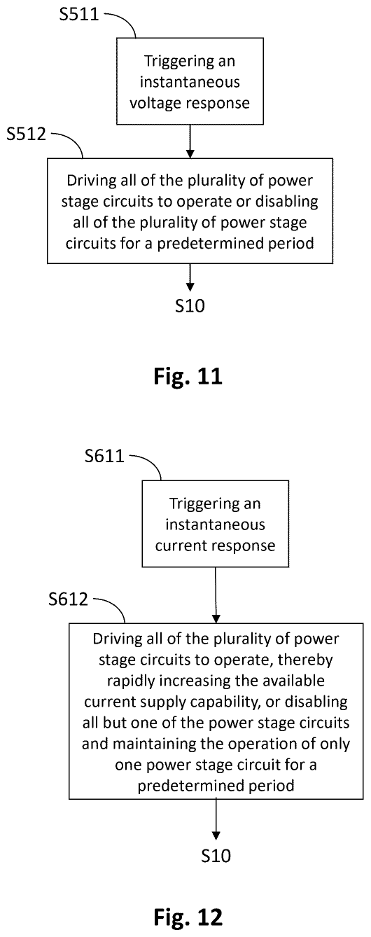

FIG. 11 illustrates a flowchart of an instantaneous voltage response operation according to one embodiment of the present invention, corresponding to the instantaneous voltage response operation described in step S51 of FIG. 10. This embodiment specifically explains the processing flow of the instantaneous voltage response performed by the control circuit when a change in the output voltage exceeds an instantaneous voltage difference threshold.

Step S511 is triggering the instantaneous voltage response. When the control circuit determines that the variation of the output voltage has exceeded a predetermined instantaneous voltage difference threshold, the instantaneous voltage response is triggered to immediately respond to sudden load demands, thereby preventing significant overshoot or undershoot of the output voltage.

Subsequently, in step S512, the control circuit drives all of the plurality of power stage circuits to operate for a predetermined period, or, in another scenario, disables all of the plurality of power stage circuits for a predetermined period, in both cases maintaining the state for a predetermined period. This full-phase activation or full-phase shutdown approach can, within an extremely short time, adjust the overall power supply capability or completely buffer and isolate the system, effectively and rapidly restoring the output voltage to a stable range and suppressing instability.

After completing the instantaneous voltage response, the process returns to step S10 of FIG. 10 to restart the next cycle of current and voltage sensing and decision control, thereby continuously monitoring the system operating status and dynamically adjusting the number of operating phases.

FIG. 12 illustrates a flowchart of an instantaneous current response operation according to one embodiment of the present invention, corresponding to the instantaneous current response process described in step S61 of FIG. 10. This embodiment specifically explains the instantaneous current response operation performed when the control circuit detects that an inductor current exceeds an instantaneous current threshold, while the change in output voltage does not exceed the instantaneous voltage difference threshold.

Step S611 is triggering the instantaneous voltage response. When at least one inductor current exceeds a predetermined instantaneous current threshold, while the variation in the output voltage has not yet reached the magnitude required to trigger the instantaneous voltage response, the control circuit triggers an instantaneous current response to effectively address transient demands caused by the output load, and to reduce the risk of voltage oscillations.

In step S612, the control circuit performs one of the following operations according to the system strategy: driving all of the plurality of power stage circuits to operate for a predetermined period, thereby rapidly increasing the available current supply capability, or disabling all but one of the power stage circuits and maintaining the operation of only one power stage circuit for a predetermined period. This approach controls the number of operating power stages to reduce the amplitude of overshoot or undershoot of the output voltage, while suppressing voltage ringing caused by frequent phase switching.

After completion of either action above, the process returns to step S10 of FIG. 10 to re-sense the inductor current of each power stage circuit, so as to further evaluate the current inductor current state and perform the next round of control decisions.

With this design, the instantaneous current response provides an immediate adjustment mechanism between the instantaneous voltage response and the slower average current control, enabling the overall control system to more flexibly handle disturbances to the output voltage caused by load variations during a transient period, thereby achieving better voltage regulation and power conversion efficiency.

In one embodiment, when the first number of operating phases determined based on at least one inductor current exceeding the instantaneous current threshold differs from the second number of operating phases determined based on the average current and an average current threshold, the first number of operating phases is given priority. That is, the instantaneous current response takes precedence over determining the number of operating phases based on the average current and at least one average current threshold.

In one embodiment, the instantaneous voltage response takes precedence over determining the number of operating phases based on the average current and at least one average current threshold.

FIG. 13 illustrates a flowchart of the triggering condition logic of the instantaneous current response according to one embodiment of the present invention, corresponding to a further condition refinement of step S60 of FIG. 10, to explain an application example.

As shown in FIG. 13, in step S60′, the control method performs the following logical determinations:
First, determining that the current inductor current is a forward inductor current;
Second, determining that the current average current is less than a first average current threshold, in other words, the corresponding second number of operating phases is less than a first predetermined number (for example, the system may have originally intended to reduce the number of operating phases to one according to the average current);
Third, confirming that at least one inductor current exceeds a first instantaneous current threshold, indicating that the instantaneous load may be too high, and that the corresponding first number of operating phases may need to be increased to a second predetermined number or more (for example, four phases or driving all of the plurality of power stage circuits to operate); and
that the second predetermined number is greater than the first predetermined number, thus having a difference in phase count.

If all of the above conditions are “Yes,” then in step S61′, which is triggering the instantaneous current response, prioritizing the instantaneous current response to adjust the current number of operating power stage phases, so as to avoid situations in which the slower average current calculation causes overshoot or undershoot of the output voltage, and to improve the overall response speed and voltage regulation capability.

For example, when the average current determines that the number of operating phases should be reduced to one (i.e., the second number of operating phases =1), but at the same time the inductor current of one phase has exceeded the instantaneous current threshold, indicating that the actual instantaneous current demand is high, the present invention preferentially triggers the instantaneous current response to drive all of the power stage circuits to operate for a predetermined period, thereby enhancing the power supply capability. If the conditions are not met, the process returns to step S10 of FIG. 10 to re-enter the current detection cycle. Through the design of this embodiment, the control method can effectively avoid misjudging the load condition when determining the number of operating phases, thereby further reducing the risk of abnormal voltage or system instability, and improving dynamic stability and conversion efficiency.

In the above embodiment, a further refinement can be made such that if the average current is not less than the first average current threshold, and the determined number of operating phases is two or three, then even if the inductor current exceeds the first instantaneous current threshold, the instantaneous current response is not triggered. That is, the number of operating phases remains as two or three, as determined based on the average current, rather than four phases or driving all of the plurality of power stage circuits to operate.

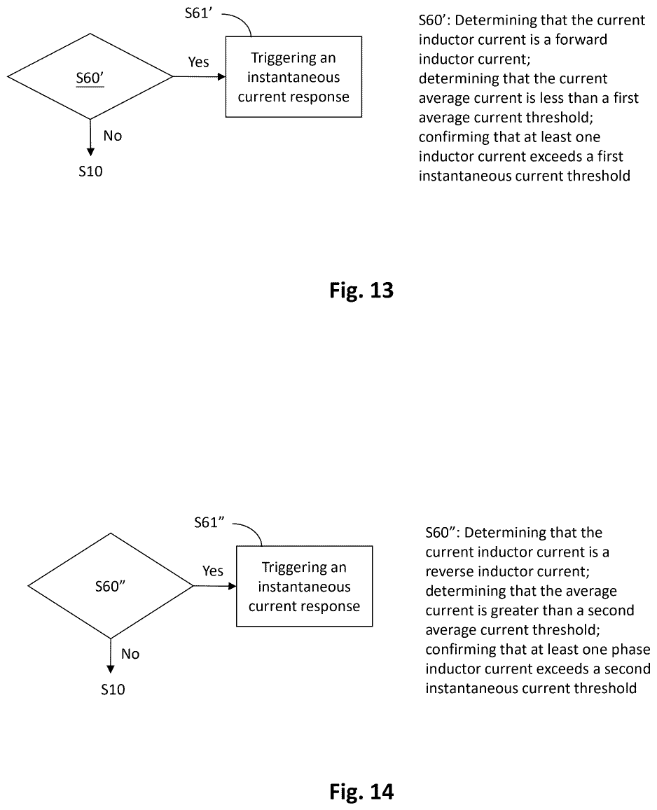

FIG. 14 illustrates a flowchart of the triggering condition logic of the instantaneous current response according to one embodiment of the present invention, corresponding to a further condition refinement of step S60 of FIG. 10. This embodiment is similar to FIG. 13, but applies to the case where the inductor current is a reverse inductor current.

As shown in FIG. 14, in step S60″, the control method performs the following logical determinations:
First, determining that the current inductor current is a reverse inductor current, i.e., energy is fed back from the output end to the power stage circuit;
Second, determining that the average current is greater than a second average current threshold, thereby determining the corresponding second number of operating phases (for example, maintaining four-phase operation);
Third, confirming that at least one phase inductor current exceeds a second instantaneous current threshold, indicating that the reverse current is too large, which is likely to cause the output voltage VO to experience overshoot and oscillation;
At this time, the first number of operating phases is less than a fourth predetermined number, and the fourth predetermined number is less than a third predetermined number (corresponding to the second number of operating phases).

If all of the above conditions are “Yes,” the process proceeds to step S61″ to trigger the instantaneous current response, using the number of operating phases corresponding to the instantaneous current response as the priority operating basis to perform phase reduction control. Specifically, the control circuit may disable all but one of the power stage circuits, maintaining the operation of only one phase for a predetermined period to rapidly reduce the supply energy, thereby avoiding significant overshoot of the output voltage and voltage regulation failure due to phase switching delays or slow average current response.

For example, if the average current corresponds to four-phase operation, but the inductor current is reverse and the inductor current of one phase is lower than−the second instantaneous current threshold (indicating that the reverse current is too large), the present invention can immediately trigger the instantaneous current response to switch to one-phase operation for a period of time, rapidly removing excess energy and suppressing VO overshoot and voltage oscillations.

If the conditions are not met, the process returns to step S10 of FIG. 10 to re-execute the sensing and logic determination process.

Through this embodiment, the voltage regulation capability under a sudden load drop can be improved, avoiding the overshoot problem caused by continued multi-phase power supply, and strengthening the dynamic stability and protection mechanism of the overall multi-phase power converter.

In the above embodiment, a further refinement can be made such that if the average current is not greater than the second average current threshold, and the determined number of operating phases is two or three (instead of maintaining four-phase operation), then even if the inductor current exceeds the second instantaneous current threshold, the instantaneous current response is not triggered. That is, the number of operating phases remains as two or three, as determined based on the average current, rather than performing phase reduction control.

The present invention has been described in considerable with reference to certain preferred embodiments thereof. It should be understood that the description is for illustrative purpose, not for limiting the broadest scope of the present invention. An embodiment or a claim of the present invention does not need to achieve all the objectives or advantages of the present invention. The title and abstract are provided for assisting searches but not for limiting the scope of the present invention. Those skilled in this art can readily conceive variations and modifications within the spirit of the present invention. For example, as shown in FIGS. 2, 3, 4, and 9B, the multi-phase power converter includes four-phase power stage circuits. However, the power stage circuits of the present invention are not limited to four-phase power stage circuits, and the present invention can be applied to any power stage circuit having two phases or more. For another example, to perform an action “according to” a certain signal as described in the context of the present invention is not limited to performing an action strictly according to the signal itself, but can be performing an action according to a converted form or a scaled-up or down form of the signal, i.e., the signal can be processed by a voltage-to-current conversion, a current-to-voltage conversion, and/or a ratio conversion, etc. before an action is performed. It is not limited for each of the embodiments described hereinbefore to be used alone; under the spirit of the present invention, two or more of the embodiments described hereinbefore can be used in combination. For example, two or more of the embodiments can be configured together, or, a part of one embodiment can be configured to replace a corresponding part of another embodiment. In view of the foregoing, the spirit of the present invention should cover all such and other modifications and variations, which should be interpreted to fall within the scope of the following claims and their equivalents.

What is claimed is:

1. A multi-phase power converter, comprising:
a plurality of power stage circuits, configured to convert an input voltage to an output voltage, wherein the plurality of power stage circuits are coupled to the input voltage, each of the power stage circuits including at least one switch controlling a corresponding inductor, the inductor delivering energy to the output voltage;
a current sensing circuit coupled to the plurality of power stage circuits and configured to sense an inductor current flowing through the inductor of each of the power stage circuits; and
a control circuit comprising an instantaneous current response module configured to trigger an instantaneous current response to increase or decrease a number of operating phases of the plurality of power stage circuits when at least one of the inductor currents exceeds an instantaneous current threshold, thereby suppressing an overshoot or an undershoot of the output voltage.

2. The multi-phase power converter of claim 1, further comprising:
an average current circuit coupled to the plurality of power stage circuits and configured to average a plurality of inductor currents of the plurality of power stage circuits to generate an average current;
wherein the control circuit further includes an average current response module configured to determine the number of operating phases according to the average current and at least one average current threshold, thereby improving a conversion efficiency.

3. The multi-phase power converter of claim 2, further comprising:
an output voltage sensing circuit coupled to the plurality of power stage circuits and configured to sense the output voltage;
wherein the control circuit further comprises an instantaneous voltage response module configured to trigger an instantaneous voltage response to increase or decrease the number of operating phases when a variation of the output voltage exceeds an instantaneous voltage difference threshold, thereby suppressing an overshoot or an undershoot of the output voltage.

4. The multi-phase power converter of claim 3, wherein, in the instantaneous voltage response, the instantaneous voltage response module drives all of the plurality of power stage circuits to operate or disables all of the plurality of power stage circuits for a predetermined period.

5. The multi-phase power converter of claim 2, wherein the average current circuit comprises a plurality of low-pass filters respectively corresponding to the plurality of power stage circuits and configured to low-pass filter the plurality of inductor currents to obtain the average current.

6. The multi-phase power converter of claim 1, wherein the current sensing circuit comprises:
a forward inductor current sensing circuit configured to sense a forward inductor current of the inductor current in each of the power stage circuits; or
a reverse inductor current sensing circuit configured to sense a reverse inductor current of the inductor current in each of the power stage circuits;
wherein the instantaneous current response module is configured to trigger the instantaneous current response to increase or decrease the number of operating phases when at least one forward inductor current exceeds an instantaneous forward current threshold or at least one reverse inductor current exceeds an instantaneous reverse current threshold.

7. The multi-phase power converter of claim 1, wherein, in the instantaneous current response, the instantaneous current response module drives all of the plurality of power stage circuits to operate, or disables other power stage circuits except one phase, such that only one phase power stage circuit remains operating for a predetermined period, thereby suppressing an overshoot or an undershoot of the output voltage.

8. The multi-phase power converter of claim 2, wherein the instantaneous current threshold is greater than the at least one average current threshold.

9. The multi-phase power converter of claim 1, wherein, when the control circuit decreases the number of operating phases, during a transient period, one of an upper bridge switch and a lower bridge switch of the at least one switch of the power stage circuit being turned OFF is kept in an OFF state, such that an inductor current flows through a body diode of the upper bridge switch or the lower bridge switch that is turned OFF, to increase an absolute value of a voltage across the inductor, thereby shortening the transient period.

10. A control method for controlling a multi-phase power converter, wherein the multi-phase power converter comprises a plurality of power stage circuits configured to convert an input voltage to an output voltage, the plurality of power stage circuits being coupled to the input voltage and each of the plurality of power stage circuits controlling a corresponding inductor through at least one switch, the inductor delivering energy to the output voltage, the control method comprising:
sensing an inductor current flowing through the inductor of each power stage circuit; and
triggering an instantaneous current response to increase or decrease a number of operating phases of the plurality of power stage circuits when at least one of the inductor currents exceeds an instantaneous current threshold, thereby suppressing an overshoot or an undershoot of the output voltage.

11. The control method of claim 10, further comprising:
averaging a plurality of inductor currents of the plurality of power stage circuits to generate an average current; and
determining the number of operating phases according to the average current and at least one average current threshold, thereby improving a conversion efficiency.

12. The control method of claim 11, further comprising:
sensing the output voltage; and
triggering an instantaneous voltage response to increase or decrease the number of operating phases when a variation of the output voltage exceeds an instantaneous voltage difference threshold, thereby suppressing an overshoot or an undershoot of the output voltage.

13. The control method of claim 12, wherein the step of triggering the instantaneous voltage response to increase or decrease the number of operating phases when the variation of the output voltage exceeds the instantaneous voltage difference threshold further comprises:
in the instantaneous voltage response, driving all of the plurality of power stage circuits to operate or disabling all of the plurality of power stage circuits for a predetermined period.

14. The control method of claim 11, wherein the step of averaging the plurality of inductor currents of the plurality of power stage circuits to generate the average current comprises:
low-pass filtering the plurality of inductor currents to obtain the average current.

15. The control method of claim 10, wherein the step of sensing the inductor current flowing through the inductor of each power stage circuit comprises:
sensing a forward inductor current of the inductor current in each of the power stage circuits; or
sensing a reverse inductor current of the inductor current in each of the power stage circuits;
wherein the instantaneous current response is triggered to increase or decrease the number of operating phases when at least one forward inductor current exceeds an instantaneous forward current threshold or at least one reverse inductor current exceeds an instantaneous reverse current threshold.

16. The control method of claim 10, wherein the step of triggering the instantaneous current response to increase or decrease the number of operating phases of the plurality of power stage circuits when at least one of the inductor currents exceeds the instantaneous current threshold further comprises:
in the instantaneous current response, driving all of the plurality of power stage circuits to operate, or disabling other power stage circuits except one phase power stage circuit, such that only the one phase power stage circuit remains operating for a predetermined period, thereby suppressing an overshoot or an undershoot of the output voltage.

17. The control method of claim 11, wherein the instantaneous current threshold is greater than the at least one average current threshold.

18. The control method of claim 10, wherein, when reducing the number of operating phases, during a transient period, one of an upper bridge switch and a lower bridge switch of the at least one switch of a power stage circuit being turned OFF is kept in an OFF state, such that an inductor current flows through a body diode of the upper bridge switch or the lower bridge switch that is turned OFF, to increase an absolute value of a voltage across the inductor, thereby shortening the transient period.

19. A control method for controlling a multi-phase power converter, wherein the multi-phase power converter comprises a plurality of power stage circuits configured to convert an input voltage to an output voltage, the plurality of power stage circuits being respectively coupled to the input voltage and each controlling a corresponding inductor through at least one switch, the inductor delivering energy to the output voltage, the control method comprising:
sensing an inductor current flowing through the inductor of each power stage circuit;
averaging a plurality of inductor currents of the plurality of power stage circuits to generate an average current;
sensing the output voltage;
determining a number of operating phases according to the average current and at least one average current threshold, thereby improving a conversion efficiency;
triggering an instantaneous voltage response to increase or decrease the number of operating phases of the plurality of power stage circuits when a variation of the output voltage exceeds an instantaneous voltage difference threshold, thereby suppressing an overshoot or an undershoot of the output voltage; and
when the variation of the output voltage does not exceed the instantaneous voltage difference threshold and at least one of the inductor currents exceeds an instantaneous current threshold, triggering an instantaneous current response to increase or decrease the number of operating phases, thereby suppressing an overshoot or an undershoot of the output voltage.

20. The control method of claim 19, further comprising: in the instantaneous voltage response, driving all of the plurality of power stage circuits to operate or disabling all of the plurality of power stage circuits for a predetermined period.

21. The control method of claim 19, further comprising: in the instantaneous current response, driving all of the plurality of power stage circuits to operate, or disabling other power stage circuits except one phase, such that only one phase power stage circuit remains operating for a predetermined period, thereby suppressing an overshoot or an undershoot of the output voltage.

22. The control method of claim 19, wherein, when a first number of operating phases determined according to at least one of the inductor currents exceeding the instantaneous current threshold is inconsistent with a second number of operating phases determined according to the average current and the average current threshold, the first number of operating phases is executed with priority as the number of operating phases.

23. The control method of claim 22, wherein, when the second number of operating phases is less than a first predetermined number, the inductor current is a forward inductor current, the first number of operating phases is greater than a second predetermined number, and the second predetermined number is greater than the first predetermined number; or when the second number of operating phases is greater than a third predetermined number, the inductor current is a reverse inductor current, the first number of operating phases is less than a fourth predetermined number, and the fourth predetermined number is less than the third predetermined number.
